(19) United States
(12) Patent Application Publication
(10) Pub. No.: US 2023/0204504 A1
(43) Pub. Date: Jun. 29, 2023

(54) METHOD AND SYSTEM FOR EXTRACTING NET SIGNALS OF NEAR INFRARED SPECTRUM

(71) Applicant: Anhui University, Hefei (CN)

(72) Inventors: Tianhong PAN, Hefei (CN); Menghu LI, Hefei (CN); Qi CHEN, Hefei (CN); Shan CHEN, Hefei (CN); Yuan FAN, Hefei (CN); Xiaofeng YU, Hefei (CN)

(21) Appl. No.: 18/109,439

(22) Filed: Feb. 14, 2023

Related U.S. Application Data
(63) Continuation of application No. PCT/CN2021/143614, filed on Dec. 31, 2021.

(30) Foreign Application Priority Data
Dec. 29, 2021 (CN) 202111634942.1

(51) Int. Cl. G01N 21/359

(52) U.S. Cl. CPC G01N 21/359

(57) ABSTRACT

Disclosed is a method for extracting net signal of near infrared spectrum and a system thereof, and relates to the technical field of near infrared spectrum. The method comprises the following steps: collecting a sample to obtain the original data of the near infrared spectrum of the sample; detecting the content of the analyte of interest by using a chemical detection method as a response variable; applying different spectral pre-processing methods and the combination of different spectral pre-processing methods to the original spectral data, and the optimal pre-processing scheme is found by using the ten-fold cross test, and selecting the wave band related to the response variables by using a Least Absolute Shrinkage and Selection Operator (LASSO) algorithm.

### CROSS-REFERENCE TO RELATED APPLICATIONS

This application is a continuation of PCT/CN2021/143614, filed on Dec. 31, 2021 and claims priority of Chinese Patent Application No. 202111634942.1, filed on Dec. 29, 2021, the entire contents of which are incorporated herein by reference.

### TECHNICAL FIELD

The application belongs to the technical field of near infrared spectrum, and in particular relates to a method for extracting net signals of near infrared spectrum and a system thereof.

### BACKGROUND

Near infrared spectrum (NIR) is more suitable for material composition analysis because its wavelength is close to the visible light region, and it has strong penetrability and then carries more sample information. In recent years, NIR technology has rapidly developed into a new analysis and research method because of its relatively accurate analysis, rapidness and simplicity. The partial least squares method is the most widely used quantitative analysis model in NIR analysis. Like the principal component regression, the partial least squares method is also a factor analysis method. In the modeling process, the spectral matrix needs to be decomposed, and a few variables extracted in the decomposition process may represent most of the information of the original spectrum. In the partial least squares regression, these variables are called principal components. However, the detection target vector is considered in the partial least squares regression in the process of principal component extraction, and the covariance between the extracted principal component and the detection target vector is maximized, which ensures the maximum correlation between the potential principal component and the detection target vector. It is necessary to use the pre-processing scheme to correct the original near infrared spectrum data before using the partial least squares method to establish the calibration model. At present, the widely used near infrared spectrum processing method mainly includes standard normal transformation, multivariate scattering correction, baseline correction and smoothing.

Although the existing pre-processing may eliminate the redundant information contained in the original spectral data, highlight the differences between the spectral signals of different samples, simplify the subsequent model and improve the prediction accuracy of the model, it is difficult to extract the net analytical signal, that is, the signal containing only the analyte we are interested in, in the near infrared spectrum by using these processing methods.

### SUMMARY

The objective of the present application is to provide a method for extracting net signals of near infrared spectrum and its system, which solves the technical problem that although the existing pre-processing may eliminate the redundant information contained in the original spectrum data, highlight the differences among different sample spectrum signals, simplify the subsequent model and improve the prediction accuracy of the model, it is difficult to extract the net analytical signal, that is, the signal containing only the analyte we are interested in, in the near infrared spectrum by using these processing methods.

To achieve the above objective, the application is realized by the following technical scheme.

A method for extracting net signals of near infrared spectrum, including the following steps:

collecting a sample to obtain original data of the near infrared spectrum of the sample;

detecting a content of an analyte of interest by using a chemical detection method as a response variable;

applying different spectral pre-processing methods(SNV,MSC,S-G,1^{st} derivation) and a combination of different spectral pre-processing methods(SNV,MSC,S-G, 1^{st} derivation) to the original spectral data, and using a ten-fold cross test to find an optimal pre-processing scheme, and selecting a wave band related to the response variable by using a LASSO algorithm;

obtaining a noise subspace by using a rank elimination method under the condition(only the content of the analyte of interest is known) of an inverse model, the noise subspace is obtained by using the rank elimination method, that is, the subspace formed by interference signals (other chemical component vectors), and a measured spectral signal is orthogonally projected to the noise subspace, and the signal perpendicular to the noise subspace is the net signal of a measured component;

establishing a predicting model, extracting correction data, and using the correction data to test performances of the model.

Optionally, a process of the rank elimination method used in a process of solving the) net signal is as follows: assuming that r(H′ 1) is a collected spectrum vector, X(N′ H) contains N near infrared spectrum samples, and cₖ (N′ 1) is the analyte concentration vector of the interest corresponding to the samples, r is decomposed into two parts r=r″+r^{^}, wherein r″ is the projection r in the noise subspace, and r^{^} is the part orthogonal to r″.

Optionally, the net signal of near infrared spectrum is calculated by rₖ^{net}=(I−S₋ₖS₋ₖ⁺)r, where S₋ₖ=span{s₁,s₂,L sₖ₋₁,sₖ₊₁,L,sₘ}, each column of a matrix is the concentration vector cₖ of the spectrum excluding the concentration of the analyte of the interest, rₖ^{net} is a pure spectrum containing only kₜₕ components, I is an identity matrix, a superscript T represents the transposition of the matrix, and a superscript + represents a pseudo-inverse matrix of the matrix; under a condition of the inverse model, there is no prior data to solve S₋ₖ matrix, so the rank elimination method is adopted to solve S₋ₖ, and the specific description is as follows: the original data is reconstructed by a principal component analysis method, and a reconstructed matrix is denoted as R.

Optionally, the solution of the noise subspace is represented as R₋ₖ=R−aĉₖd^{T}, where ĉₖ is the projection ĉₖ=RR⁺cₖ of cₖ in the reconstructed matrix space, and d^{T} is the average spectrum of all correction sets; a calculation method of scalar a is as follows:

$$a = \frac{1}{{d}^{T} {R}^{+} {\hat{c}}_{k}} ;$$

for the near infrared spectrum data r_{k,un} of unknown samples, a calculation method of the net analysis signal of the analyte is as follows: r_{k,un}^{net}=(I−R₋ₖ^{T}(R₋ₖ^{T})⁺)r_{k,un}.

Optionally, the predicting model is established by using a partial least squares(PLS) method, a measurement coefficient(R²) of a prediction set is used as an evaluation standard, an optimal pre-processing scheme is selected without under-fitting and over-fitting, an optimal band is selected by using LASSO(Least absolute shrinkage and selection operator), the selected band is used as an input, and the net analysis signal is extracted as final correction data; finally, the predicting model is established by using the partial least squares(PLS) method, and the performances of the model is tested.

Optionally, a penalty coefficient in a wavelength selection method (LASSO) is determined by the ten-fold cross test.

A system for extracting a net signal of near infrared spectrum, including:

a sampling module: the sampling module collects samples to obtain the original data of the near infrared spectrum of the samples;

a predicting module: the predicting module uses the chemical detection method to detect the content of the analyte of interest as the response variable;

a processing module: the processing module applies different spectral pre-processing methods(SNV,MSC,S-G,1^{st} derivation) and the combination of different spectral pre-processing methods(SNV,MSC,S-G,1^{st} derivation) to the original spectral data, and finds out the optimal pre-processing scheme by using the ten-fold cross test, and selects the wave band related to the response variable by using the LASSO algorithm;

an extracting module: under the condition of inverse model (only the content of the analyte of interest is known), the extracting module uses the rank elimination method to obtain the noise subspace, that is, the subspace formed by the interference signal (other chemical component vectors), and the measured spectral signal is orthogonally projected to the noise subspace, and the signal perpendicular to the noise subspace is the net signal of the measured component; and

a detecting module: the detecting module establishes the predicting model, extracts correction data, and uses the correction data to detect the performances of the model.

The embodiment of the application has the following beneficial effects.

According to one embodiment of the application, the number of principal components in the optimal partial least squares model is reduced by extracting the net analysis signal of the near infrared spectrum, so that the model complexity is simplified and the accuracy and robustness of the model are improved; the introduction of the pre-processing scheme changes the direction of the near infrared spectrum disturbance, so that the projection of the spectrum disturbance in the direction of the net signal is reduced; the introduction of LASSO reduces the modulus of the disturbance vector, so as to further eliminate the influence of interference on the extraction of the net analysis signal. Moreover, the introduction of wavelength selection method solves the problem of multiple correlation of near infrared spectral data and reduces the modulus of spectral disturbance vector. The introduction of these two spectral data processing schemes increases the signal-to-noise ratio of the net analysis signal, thus improving the accuracy and robustness of the model.

Of course, it is not necessary to achieve all the advantages mentioned above for any product to implement the present invention.

### BRIEF DESCRIPTION OF THE DRAWINGS

The drawings of the specification which form a part of this application are used to provide a further understanding of the present application. The illustrative embodiments of the present application and the descriptions are used to explain the present application, and do not constitute undue limitations on the present application. In the attached drawings:

FIG. 1 is the original tea spectral data in the near infrared spectral analysis of tea in Embodiment 1 of the present application;

FIG. 2 is the original tea spectral data in the near infrared spectral analysis of tea in Embodiment 1 of the present application;

FIG. 3 is the spectral data of tea after pre-processing with S-G (9-point window) +SNV in Embodiment 1 of the present application;

FIG. 4 is a net analysis signal of a piece of tea spectral data after pre-processing in Embodiment 1 of the present application;

FIG. 5 is the near infrared wave band selected by LASSO in Embodiment 1 of the present application;

FIG. 6 is a model predicting result based on the best pre-processing method and LASSO in Embodiment 1 of the present application;

FIG. 7 is a model predicting result based on common processing method and LASSO in Embodiment 1 of the present application.

### DETAILED DESCRIPTION OF THE EMBODIMENTS

The technical solutions in the embodiments of the present application will be clearly and completely described below with reference to the drawings in the embodiments of the present application. Obviously, the described embodiments are only part of the embodiments of the present application, but not all of them. The following description of at least one exemplary embodiment is merely illustrative in nature, and is in no way intended to limit the application, its application or use.

In order to keep the following description of the embodiments of the present application clear and concise, detailed descriptions of known functions and known components are omitted in the present application.

In this embodiment, a method for extracting net signal of near infrared spectrum is provided, including the following steps.

collecting a sample to obtain original data of the near infrared spectrum of the sample;

detecting a content of an analyte of interest by using a chemical detection method as a response variable;

applying different spectral pre-processing methods(SNV,MSC,S-G,1^{st} derivation) and a combination of different spectral pre-processing methods(SNV,MSC,S-G,1^{st} derivation) to the original spectral data, and using a ten-fold cross test to find an optimal pre-processing scheme, and selecting a wave band related to the response variable by using a LASSO algorithm;

using the LASSO algorithm to select the wave band related to the response variable and as input data;

obtaining a noise subspace by using a rank elimination method under the condition(only the content of the analyte of interest is known) of an inverse model, the noise subspace is obtained by using the rank elimination method, that is, the subspace formed by interference signals (other chemical component vectors), and a measured spectral signal is orthogonally projected to the noise subspace, and the signal perpendicular to the noise subspace is the net signal of a measured component;

establishing a predicting model, extracting correction data, and using the correction data to test performances of the model.

A system for extracting a net signal of near infrared spectrum, including:

a sampling module: the sampling module collects the samples to obtain the original data of the near infrared spectrum of the samples;

a predicting module: the predicting module uses the chemical detecting method to detect the content of the analyte of interest as the response variable;

a processing module: the processing module applies different spectral pre-processing methods(SNV,MSC, S-G, 1^{st} derivation) and the combination of different spectral pre-processing methods(SNV,MSC, S-G, 1^{st} derivation) to the original spectral data, and finds out the optimal pre-processing scheme by using the ten-fold cross test, and selects the wave band related to the response variable by using the LASSO algorithm;

an extracting module: under the condition of inverse model (only the content of the analyte of interest is known), the extracting module uses the rank elimination method to obtain the noise subspace, that is, the subspace formed by the interference signal (other chemical component vectors), and the measured spectral signal is orthogonally projected to the noise subspace, and the signal perpendicular to the noise subspace is the net signal of the measured component; and

a detecting module: the detecting module establishes the predicting model, extracts correction data, and uses the correction data to detect the performances of the model.

The application of one aspect of this embodiment is as follows: firstly, the PLS correction model is established by comparing the net analysis signals extracted by different pre-processing methods, and the optimal pre-processing scheme is obtained by comparing the experimental results. Finally, the wavelength of the preprocessed spectral data is selected by LASSO to obtain the final spectral correction data, and the net signal is extracted, so as to further improve the signal-to-noise ratio of the spectral signal and simplify the model.

By extracting the net analysis signal of near infrared spectrum, the number of principal components in the optimal model of partial least squares method is reduced, which simplifies the complexity of the model and improves the accuracy and robustness of the model. The introduction of pre-processing scheme changes the direction of near infrared spectrum disturbance, which makes the projection of spectrum disturbance in the direction of net signal decrease. The introduction of LASSO reduces the modulus of disturbance vector, and further eliminates the influence of interference on the extraction of net analysis signal. Moreover, the introduction of wavelength selection method solves the problem of multiple correlation of near infrared spectral data and reduces the modulus of spectral disturbance vector. The introduction of these two spectral data processing schemes increases the signal-to-noise ratio of the net analysis signal and hence improve the accuracy and robustness of the model.

The process of the rank elimination method used in a process of solving the net signal in the embodiment is as follows: assuming that r(H′ 1) is a collected spectrum vector, X(N′ H) contains N near infrared spectrum samples, and cₖ (N′ 1) is the analyte concentration vector of the interest corresponding to the samples, r is decomposed into two parts r=r″+r^{^}, where r″ is the projection r in the noise subspace, and r^{^} is the part orthogonal to r″, the analyte concentration cₖ of interest is only related to this part of the signal in the near infrared spectrum.

The net signal of near infrared spectrum in the embodiment is calculated by rₖ^{net}=(I−S₋ₖS₋ₖ⁺)r, where S₋ₖ=span{s₁,s₂,L sₖ₋₁,sₖ₊₁L,sₘ}, each column of the matrix is the concentration vector cₖ of the spectrum excluding the components contained in the concentration of the analyte of interest(interfering components), rₖ^{net} is a pure spectrum containing only kₜₕ components, I is an identity matrix, a superscript T represents the transposition of the matrix, and a superscript + represents a pseudo-inverse matrix of the matrix.

In this embodiment, under the condition of inverse model, there is no prior data to solve S₋ₖ matrix, so the rank elimination method is adopted to solve the matrix. The specific description is as follows: principal component analysis (PCA) is applied to reconstruct the original data, and the reconstructed matrix is recorded as R. The objective is to avoid R^{T}R unsatisfied rank and inability to calculate regression coefficient and eliminate random noise.

The solution of the noise subspace in this embodiment is expressed as R₋ₖ=R−aĉₖd^{T}, where ĉₖ is the projection ĉₖ=RR⁺cₖ of cₖ in the A-dimensional space, and d^{T} is the average spectrum of all correction sets. The calculation method of scalar a is

$$a = \frac{1}{{d}^{T} {R}^{+} {\hat{c}}_{k}} .$$

For the near infrared spectrum data r_{k,un} of the unknown sample in this embodiment, the calculation method of the net analysis signal about the analyte is as follows: r_{k,un}^{net}=(I−R₋ₖ^{T}(R₋ₖ^{T})⁺)r_{k,un}.

In this embodiment, the predicting model is established by using a partial least squares(PLS) method, a measurement coefficient(R²) of a prediction set is used as an evaluation standard, an optimal pre-processing scheme is selected without under-fitting and over-fitting, an optimal band is selected by using LASSO(Least absolute shrinkage and selection operator), the selected band is used as an input, and the net analysis signal is extracted as final correction data; finally, the predicting model is established by using the partial least squares(PLS) method, and the performances of the model is tested.

### Embodiment 1

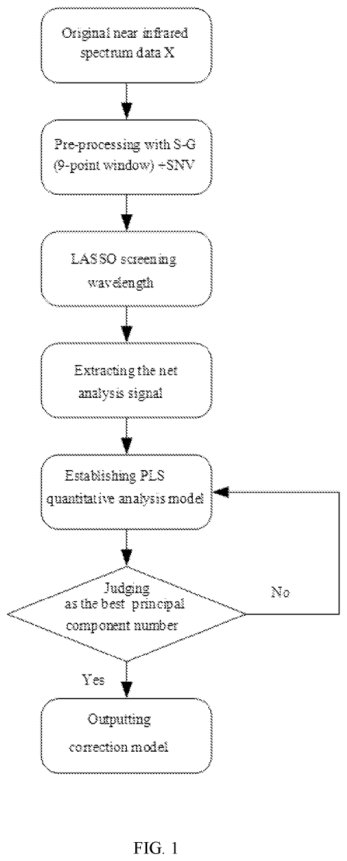

This embodiment provides a method for extracting net analysis signals in the near infrared spectrum analysis of tea, and the process of selecting the model optimization scheme for predicting the sugar content in tea (as shown in FIG. 1). The specific steps are as follows:

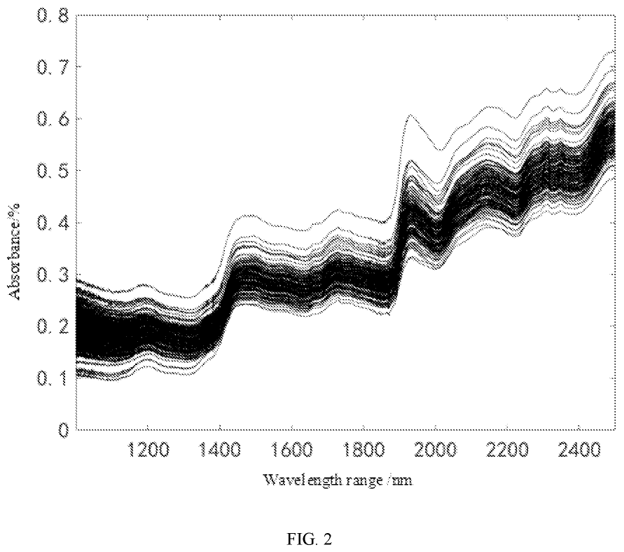

S1, firstly, preparing samples to be tested, collecting the spectral data of green tea as X∈ [symbol] ^{120×12446} (as shown in FIG. 2), determining the data of sugar content in the sample determined by liquid chromatography as Y∈ [symbol] ^{120 ×1}, and sampling the samples randomly according to the ratio of 7:3 and dividing the samplings into a correction set and a prediction set;

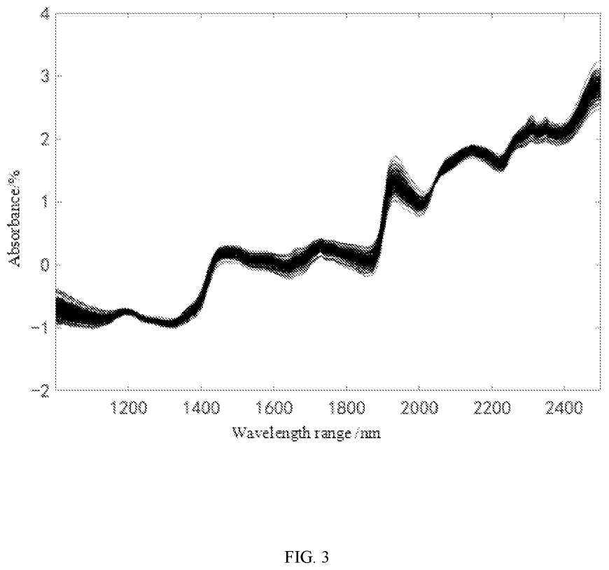

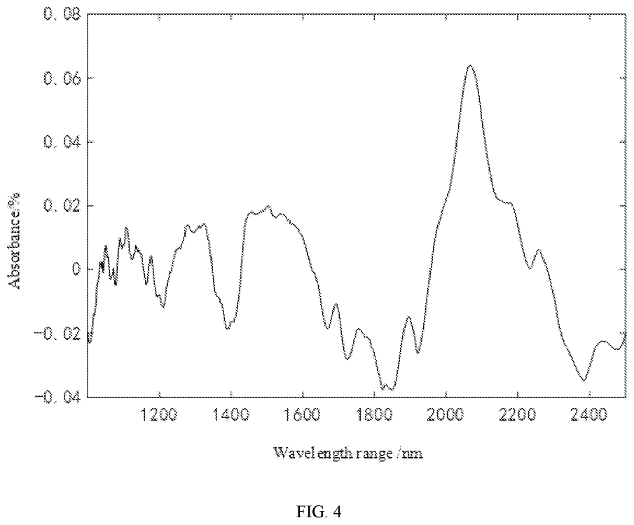

S2, using different pre-processing schemes to process the original near infrared spectrum data, extracting the net analysis signal only related to sugar content, establishing PLS quantitative analysis model, taking the accuracy of prediction set as the evaluation standard, selecting the best pre-processing method, and finally obtaining the best pre-processing method: 9-point S-G smoothing combined with SNV. After pre-processing, the near infrared spectrum is shown in FIG. 3, and the extracted net analysis signal is shown in FIG. 4.

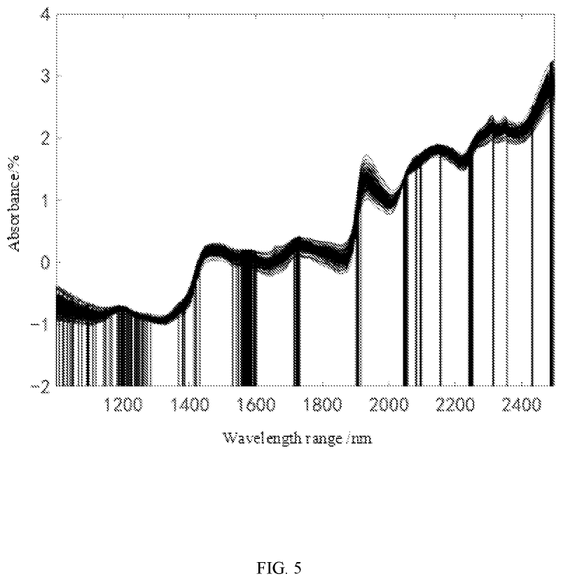

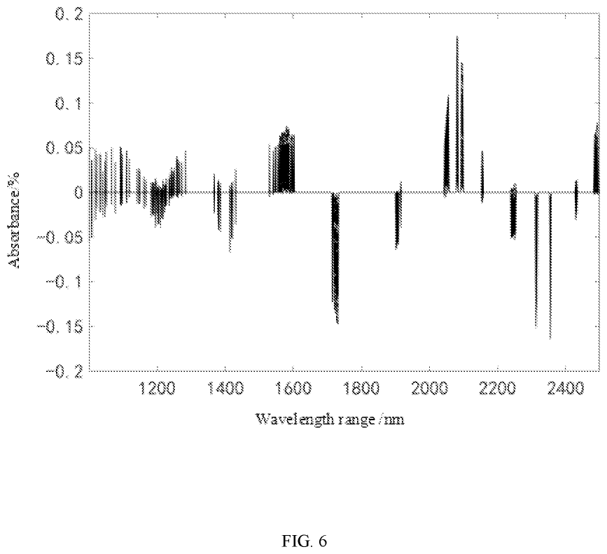

S3, using LASSO to select the wavelength of the pre-processed near infrared spectrum, and using 10-fold cross-validation to determine the optimal penalty coefficient, the selected wave band is shown in FIG. 5, and then the net analysis signal of the processed spectrum data is extracted as shown in FIG. 6, which is used as the final modeling data;

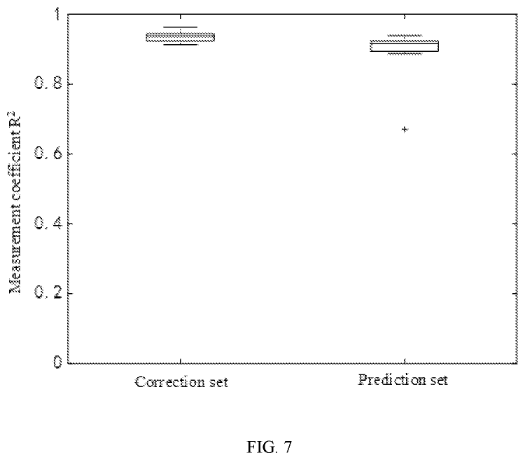

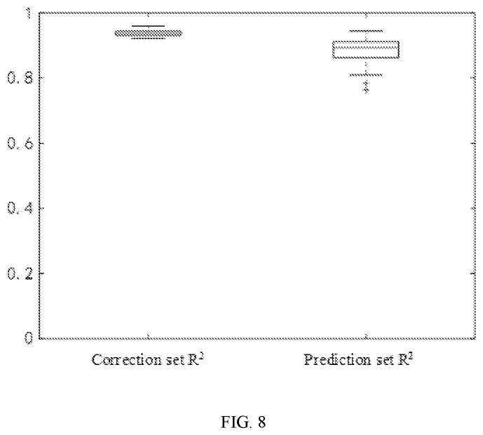

S4, establishing a quantitative analysis model by using PLS based on the final spectral data, and analyzing the performances of the model. Under the condition that the optimal PLS principal component is 2, the results of 100 Monte Carlo simulation experiments are shown in FIG. 7, and the median of the prediction set R² is 0.91. Comparing the PLS models under the common processing method (S-G+SNV), the results of 100 Monte Carlo simulation experiments are shown in FIG. 8, and the median of prediction set R² is 0.89 under the condition that the optimal PLS principal component is 7.

Through comparison, it can be known that the method of the application may measure the sugar content in green tea with high accuracy through near infrared spectrum data, and the accuracy of the obtained model is better than that of the traditional modeling method.

The above embodiments are only used to illustrate the technical scheme of the present application, but not to limit it. Although the present application has been described in detail with reference to the foregoing embodiments, it should be understood by those skilled in the art that they can still modify the technical schemes described in the foregoing embodiments, or equivalently replace some of the technical features, and these modifications or substitutions do not make the essence of the corresponding technical schemes deviate from the spirit and scope of the technical schemes of the various embodiments of the present application.

What is claimed is:

1. A method for extracting net signals of near infrared spectrums, comprising following steps:
collecting samples to obtain original data of the near infrared spectrums of the samples;
detecting a content of an analyte of interest by using a chemical detection method as a response variable;
applying different spectral pre-processing methods and a combination of different spectral pre-processing methods to the original spectral data, and using a ten-fold cross test to find an optimal pre-processing scheme, and selecting a wave band related to the response variable by using a Least Absolute Shrinkage and Selection Operator (LASSO) algorithm;
obtaining a noise subspace by using a rank elimination method with an inverse model, and projecting a measured spectral signal orthogonally to the noise subspace, and taking signals perpendicular to the noise subspace as net signals of a measured component;
establishing a predicting model, extracting correction data, and using the correction data to test performances of the model.

2. The method for extracting net signals of near infrared spectrums according to claim 1, wherein a process of the rank elimination method used in a process of solving the net signals is as follows: assuming that r(H′ 1) is a collected spectrum vector, X(N′ H) contains N near infrared spectrum samples, and cₖ(N′ 1) is a analyte concentration vector of the interest corresponding to the samples, r is decomposed into two parts r=r″'r^, r″ is a projection r in the noise subspace, and r^{^} is a part orthogonal to r″.

3. The method for extracting a net signal of near infrared spectrum according to claim 2, wherein the net signals of the near infrared spectrums are calculated by rₖ^{net}=(I−S₋ₖS₋ₖ⁺)r, wherein S₋ₖ=span{s₁,s₂,L sₖ₋₁,sₖ₊₁,L,sₘ}, each column of a matrix is the concentration vector cₖ of the spectrum excluding the concentration of the analyte of the interest, rₖ^{net} is a pure spectrum containing only kₜₕ components, I is an identity matrix, a superscript T represents transposition of the matrix, and a superscript + represents a pseudo-inverse matrix of the matrix.

4. The method for extracting net signals of near infrared spectrums according to claim 3, wherein with the inverse model, there is no prior data to solve S₋ₖ matrix, so the rank elimination method is adopted to solve S₋ₖ, and the specific description is as follows: the original data is reconstructed by a principal component analysis method, and a reconstructed matrix is denoted as R.

5. The method for extracting net signals of near infrared spectrums according to claim 4, wherein a solution of the noise subspace is represented as R₋ₖ=R−aĉₖd^{T}, wherein ĉₖ is the projection ĉₖ=RR⁺cₖ of cₖ in reconstructed matrix space, and d^{T} is an average spectrum of all correction sets.

6. The method for extracting net signals of near infrared spectrums according to claim 5, wherein a calculation method of scalar a is as follows:
$$a = \frac{1}{{d}^{T} {R}^{+} {\hat{c}}_{k}} .$$

7. The method for extracting net signals of near infrared spectrums according to claim 6, wherein for the near infrared spectrum data r_{k,un} of unknown samples, a calculation method of the net analysis signal of the analyte is as follows: r_{k,un}^{net}=(I−R₋ₖ^{T}(R₋ₖ^{T})⁺)r_{k,un}.

8. The method for extracting net signals of near infrared spectrums as claimed in claim 7, wherein the predicting model is established by using a partial least squares method, a measurement coefficient of a prediction set is used as an evaluation standard, an optimal pre-processing scheme is selected without under-fitting and over-fitting, an optimal band is selected by using the LASSO algorithm, the selected band is used as an input, and the net analysis signal is extracted as final correction data; finally, the predicting model is established by using the partial least squares method, and the performance of the model is tested.

9. The method for extracting net signals of near infrared spectrums according to claim 8, wherein a penalty coefficient in a wavelength selection method is determined by the ten-fold cross test.

10. A system for extracting net signals of near infrared spectrums, comprising:
a sampling module used to collect the samples to obtain the original data of the near infrared spectrums of the samples;
a predicting module to use the chemical detection method to detect the content of the analyte of interest as the response variable;
a processing module used to apply different spectral pre-processing methods and the combination of different spectral pre-processing methods to the original spectral data, and find out the optimal pre-processing scheme by using the ten-fold cross test, and select the wave band related to the response variable by using the LASSO algorithm;
an extracting module to use the rank elimination method to obtain the noise subspace with the inverse model, wherein the measured spectral signal is orthogonally projected to the noise subspace, and the signal perpendicular to the noise subspace is the net signal of the measured component; and
a detecting module used to establish the predicting model, extract correction data, and use the correction data to detect the performances of the model.
